(19) United States
(12) Patent Application Publication
(10) Pub. No.: US 2025/0118772 A1
(43) Pub. Date: Apr. 10, 2025

(54) PLATINUM-PALLADIUM ALLOY CATALYST TO ENHANCE PERFORMANCE IN FUEL CELLS CONTAINING PHOSPHORIC ACID OR PHOSPHONATED IONOMER

(71) Applicant: Toyota Motor Engineering & Manufacturing North America, Inc., Plano, TX (US)

(72) Inventors: Honghong Lin, Ann Arbor, MI (US); Siwen Wang, Ann Arbor, MI (US); Hongfei Jia, Ann Arbor, MI (US); Chen Ling, Troy, MI (US); Gaohua Zhu, Ann Arbor, MI (US); Liang Wang, Saline, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/482,353

(22) Filed: Oct. 6, 2023

(51) Int. Cl. H01M 4/92; H01M 4/86; H01M 8/0293; H01M 8/086; H01M 8/10; H01M 8/1004; H01M 8/1023; H01M 8/103

(52) U.S. Cl. CPC H01M 8/0232

(57) ABSTRACT

A platinum-palladium alloy catalyst, and a phosphoric acid or a phosphonated ionomer contacting the platinum-palladium alloy catalyst in a fuel cell. Phosphoric acid fuel cells (PAFCs, with phosphoric-acid-saturated silicon carbide matrix) employing the platinum-palladium alloy catalyst, and, a phosphoric acid or a phosphonated ionomer contacting the platinum-palladium alloy catalyst are disclosed. High-temperature polymer electrolyte membrane fuel cells (HT-PEMFCs, with phosphoric-acid-contained polymer matrix) employing the platinum-palladium alloy catalyst, and a phosphoric acid or a phosphonated ionomer contacting the platinum-palladium alloy catalyst are also disclosed.

### FIELD

The present disclosure generally relates to high temperature fuel cells having phosphoric acid or a phosphonated ionomer and, more particularly, platinum-palladium alloy catalysts and/or membrane electrode assemblies having platinum-palladium alloy catalysts.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly nor implicitly admitted as prior art against the present technology.

Fuel cells are devices that generate electricity through electrochemical redox reactions, not combustion. In short, they convert the chemical energy of fuels, such as hydrogen or methane, directly into electrical energy by combining them with oxygen. Fuel cells are differentiated by the type of electrolyte separating the fuel from the oxygen. Types of fuel cells based on the kind of electro-chemical reactions that take place in the cell, the catalysts, the operating temperature, the fuel, and other factors include: Proton Exchange Membrane (PEM) fuel cells; Alkaline fuel cells; Solid oxide fuel cells; and Phosphoric acid fuel cells.

Fuel cell vehicles (FCVs) are considered to be more efficient than conventional internal combustion engine vehicles and they have a zero emission powertrain platform. All current commercially available fuel cell vehicles use polymer electrolyte membrane fuel cells (PEMFCs), which include stacks of membrane electrode assemblies (MEAs). While PEMFC technology has been commercialized for decades, it still faces major challenges of high material costs and substantial performance gaps.

PEMFCs typically require efficient proton transport in their electrocatalyst layers in order to carry out the oxygen reduction reaction, and often underperform in very dry conditions due to poor proton transport in the absence of sufficient water. At the same time, excessive water can also impair performance. Moreover, the oxygen reduction reaction (ORR) that occurs at the cathode of PEMFCs has relatively slow chemical kinetics, thus posing an obstacle to cell performance. Even with a platinum catalyst, such cells typically suffer from significant overpotential loss and poor durability. Large amounts of catalyst are often used in order to overcome performance issues; however, this substantially increases cost. Efforts to decrease mass loading in PEMFC MEAs to lower costs have resulted in a decrease in high current density (HCD) performance.

Heavy-duty transportation is a critical area for decarbonization as it contributes to 25% of total fuel consumption and 23% of carbon dioxide emissions. Heavy duty vehicles (HDVs) generate more waste and require a higher temperature (>120° C.) compared to light-duty vehicles (LDVs) to meet the automotive heat rejection constraint. However, PEMFCs widely used in LDVs are not readily applied at a higher temperature because at temperatures above 100° C. proton conductivity decreases substantially as the membrane dehydrates.

Platinum is the most active monometallic element for ORR, whereas palladium shows poorer ORR activity than platinum due to stronger binding of oxygen species. Platinum-palladium nanoparticles have shown poorer ORR activity than platinum in low temperature PEMFCs (LT-PEMFCs).

The presence of phosphoric acid in PEMFC MEAs also adversely affects the performance of catalyst. Phosphoric acid poisoning of platinum group catalysts suppresses the activity of ORR in high-temperature PEMFCs (HT-PEMFCs) due to competitive adsorption of phosphate on platinum surface, which decreases the surface reactive site number on the platinum catalysts. On carbon supported pure platinum (Pt/C), the phosphate competes with oxygen to adsorb onto Pt site thereby decreasing the reaction sites for ORR.

It would be desirable to develop improved catalysts and PEMFC catalyst layers having superior proton transport capability under varying humidity conditions, availability of active catalyst, improved function and/or durability with lower cost.

### SUMMARY

This section provides a general summary of the disclosure and is not a comprehensive disclosure of its full scope or all of its features.

In various aspects, the present teachings provide an oxygen reduction reaction (ORR) catalyst comprising: a platinum-palladium alloy catalyst and a phosphoric acid or a phosphonated ionomer contacting the platinum-palladium alloy catalyst.

The phosphonated ionomer can be poly (2,3,5,6-tetrafluorostyrene-4-phosphonic acid) (PWN) or poly(tetraflurostyrene phosphonic acid-copentafluorostyrene) pSOL® (Fuel Cell Store).

In another aspect, the present disclosure provides a phosphoric acid fuel cell (PAFC) comprising the ORR catalyst. The PAFC further includes a phosphoric acid-saturated silicon carbide matrix in physical contact with the ORR catalyst.

In another aspect, the present disclosure provides a high temperature polymer electrolyte membrane fuel cell (HT-PEMFC) comprising an ORR catalyst and a phosphoric acid-contained polymer matrix in physical contact with the ORR catalyst. The (ORR) catalyst comprises: a platinum-palladium alloy catalyst and a phosphoric acid or a phosphonated ionomer contacting the platinum-palladium alloy catalyst. The phosphoric acid-contained polymer matrix can be phosphoric acid-polybenzimidazole (PA-PBI) or phosphoric acid-doped ammonium-biphosphate ion pair coordinated polyphenylene (PA-QAPOH).

In another aspect, the present disclosure relates to a membrane electrode assembly (MEA) for a polymer electrolyte membrane fuel cell. The MEA comprises at least one catalyst layer which comprises a platinum-palladium alloy catalyst; and, a phosphoric acid or a phosphonated ionomer.

In another aspect, the present disclosure relates to a membrane electrode assembly (MEA) for a polymer electrolyte membrane fuel cell, wherein the MEA comprises an anodic catalyst layer; a cathodic catalyst layer comprising carbon supported cathodic catalyst particles of a platinum-palladium alloy, and a phosphoric acid or a phosphonated ionomer; and, a phosphoric acid-contained polymer matrix mediating protic communication between the anodic catalyst layer and the cathodic catalyst layer.

In yet another aspect, the present disclosure provides a polymer electrolyte membrane fuel cell (PEMFC) comprising a membrane electrode assembly (MEA). Each MEA comprises: comprises an anodic catalyst layer; a cathodic catalyst layer comprising carbon supported cathodic catalyst particles of a platinum-palladium alloy, and a phosphoric acid or a phosphonated ionomer; and, a phosphoric acid-contained polymer matrix mediating protic communication between the anodic catalyst layer and the cathodic catalyst layer. The PEMFC can be a high temperature PEMFC (HT-PEMFC) operating at a temperature ranging from about 80° C. to about 230° C. The PEMFC can be operating at a potential ranging from about 0 V to about 1.0 volts.

In these different aspects, the platinum-palladium alloy catalyst is a solid solution catalyst. The platinum-palladium alloy catalyst can comprise nanoparticles of the platinum-palladium alloy. The catalyst can also include phosphoric acid in contact with the platinum-palladium alloy catalyst. The catalyst can also include a phosphonated ionomer in contact with the platinum-palladium alloy catalyst. The catalyst can include a phosphoric acid-saturated silicon carbide matrix in physical contact with the platinum-palladium alloy catalyst. The catalyst can also include a phosphoric acid-contained polymer matrix in physical contact with the platinum-palladium alloy catalyst.

Further areas of applicability and various methods of enhancing the above technology will become apparent from the description provided herein. The description and specific examples in this summary are intended for purposes of illustration only and are not intended to limit the scope of the present disclosure.

### DRAWINGS

The present teachings will become more fully understood from the detailed description and the accompanying drawings wherein:

FIG. 1 is a schematic cross sectional view of an example of a membrane electrode assembly of the present disclosure.

FIG. 2 is a schematic cross-sectional view of a portion of an exemplary fuel cell of the present disclosure.

FIG. 3 is a schematic cross-sectional view of a portion of an exemplary fuel cell of the present disclosure.

FIG. 4A is a schematic of oxygen and dihydrogen phosphate (H₂PO₄⁻) adsorption on pristine platinum (Pt) showing Pt (large open circles), oxygen (circle with cross), phosphorus (circle with dots and marked as H₂PO₄⁻) and hydrogen (small, filled circles).

FIG. 4B is a schematic of oxygen and dihydrogen phosphate (H₂PO₄⁻) adsorption on bimetallic platinum-palladium alloy catalyst surface showing Pt (large open circles), palladium (Pd) (large circles with diagonal lines), oxygen (circle with cross), phosphorus (circle with dots and marked as H₂PO₄⁻) and hydrogen (small, filled circles).

FIG. 5A shows a transmission electron microscopy (TEM) image of carbon supported platinum-palladium (Pt—Pd/C) nanoparticles.

FIG. 5B shows Scanning TEM image of a typical Pt—Pd/C nanoparticle.

FIG. 5C shows a corresponding elemental map of a typical Pt—Pd/C nanoparticle shown in FIG. 5B.

FIG. 6A shows room temperature rotating disk electrode (RT-RDE) study of cyclic voltammetry (CV) comparison of carbon-supported platinum nanoparticle (Pt/C) catalyst in the absence of phosphoric acid (reaction in 0.1 molar (M) perchloric acid (HClO₄)) and in the presence of phosphoric acid (reaction in 0.1 M HClO₄ and 0.1 M H₃PO₄) at room temperature (about 25° C.) with arrows showing phosphate (H₂PO₄⁻) adsorption and metal-oxide (M-O) reduction, x-axis shows current density (j) in milliamperes mA/cm²; y axis shows potential (E) versus reversible hydrogen electrode (RHE) in volts.

FIG. 6B shows RT-RDE study of cyclic voltammetry comparison of carbon-supported platinum-palladium nanoparticle (PtPd/C) catalyst in the absence of phosphoric acid (reaction in 0.1 M perchloric acid (HClO₄)), and in the presence of diluted phosphoric acid (reaction in 0.1 M HClO₄ and 0.1 M H₃PO₄) at room temperature (about 25° C.) with arrows showing H₂PO₄ adsorption and metal-oxide (M-O) reduction, x-axis shows current density (j) in milliamperes mA/cm²; y axis shows potential (E) versus reversible hydrogen electrode (RHE) in volts.

FIG. 7A shows RT-RDE study of ORR mass activity comparison of Pt/C, Pt—Pd/C and carbon-supported palladium (Pd/C) nanoparticle catalysts at 0.9 V in absence of phosphoric acid (reaction in 0.1 M HClO₄) at room temperature.

FIG. 7B shows ORR mass activity comparison of Pt/C and Pt—Pd/C nanoparticle catalyst at 0.9 V in presence of diluted phosphoric acid (reaction in 0.1 M HClO₄ and 0.1 M H₃PO₄) at room temperature (RT-PA_0.9V, RT-RDE study); at 0.9 V in concentrated H₃PO₄ at a high temperature of 160° C. (HT-PA_0.9V, high-temperature rotating disk electrode (HT-RDE) study); and, at 0.82 V in concentrated H₃PO₄ at 160° C. (HT-PA_0.82V; HT-RDE study).

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific examples within the scope of this technology. Further, certain aspects may incorporate features from a combination of figures.

### DESCRIPTION

The present teachings describe a platinum-palladium (Pt—Pd) alloy catalyst for a fuel cell having a phosphoric acid as the electrolyte. An oxygen reduction reaction (ORR) Pt—Pd alloy catalyst contacted by the phosphoric acid and incorporated at the cathode of a fuel cell has superior ORR activity and stability as compared to a pure platinum catalyst contacted by phosphoric acid at the cathode.

On carbon supported pure platinum (Pt/C), phosphate competes with oxygen to adsorb onto Pt sites thereby decreasing the reaction sites for ORR. In bimetallic Pt—Pd alloy catalysts, Pd sites can bind with oxygen more strongly, which could increase the concentration of oxygen on the surface of the catalyst. Pd also binds phosphate more strongly, which could make more Pt sites available on the Pt—Pd alloy catalyst for oxygen binding as compared to a pure Pt catalyst. Therefore, Pt—Pd alloy catalysts in phosphoric acid show higher ORR activity than a pure Pt catalyst in phosphoric acid or a phosphonated ionomer.

ORR catalysts of the present teachings include a platinum-palladium alloy catalyst; and, a phosphoric acid or a phosphonated ionomer contacting the platinum-palladium alloy catalyst. ORR catalysts can include nanoparticles of the Pt—Pd alloy catalyst. The nanoparticles are contacted by the aforementioned phosphoric acid or a phosphonated ionomer resulting in superior activity and stability. The ORR catalyst is further contacted by a phosphoric acid-contained polymer matrix resulting in superior activity and stability.

Thus, a catalyst composition for catalyzing ORR (referred to alternatively as an ORR catalyst) in a PEMFC is disclosed. The catalyst composition includes a solid solution metal catalyst that will typically include particles or another high-surface-area form of a catalytic platinum-palladium alloy. In some examples, the catalyst composition will have particles of a platinum-palladium containing alloy. The catalytic solid solution metal particles can be nanoparticles, such as nanoparticles of a platinum-palladium containing alloy.

In some examples, the solid catalyst will include particles of a catalytic platinum-palladium containing alloy in admixture with particles of another material, such as carbon, which can be selected from carbon black, graphite, activated carbon and carbon nanotubes.

The size and shape of the catalytic platinum-palladium alloy particles can be optimized to maximize total surface area of the catalyst and reaction sites available to participate in the reactions per volume of catalyst used. In some examples, the particles of a catalytic platinum-palladium alloy will have a specific surface area of at least 10 m²/g, or 20 m²/g, or 30 m²/g, or 40 m²/g, or 50 m²/g, or 60 m²/g, or 70 m²/g, or 80 m²/g, or 90 m²/g, or 100 m²/g. In some examples, the particles of a catalytic platinum-palladium alloy will be nanoparticles having an average maximum dimension of less than 100 nm, or less than 90 nm, or less than 80 nm, or less than 70 nm, or less than 60 nm, or less than 50 nm, or less than 40 nm, or less than 30 nm, or less than 20 nm, or less than 10 nm. In some specific examples, the catalyst composition will include platinum-palladium alloy nanoparticles having an average maximum dimension of 2-5 nm in diameter. In some examples, the particles of a catalytic platinum-palladium alloy will include porous particles.

When catalyst particle is contacting phosphoric acid, a catalyst of platinum-palladium alloy nanoparticles improves ORR activity, and MEA performance as discussed further below.

In some examples, the ORR catalyst can be within a phosphoric acid fuel cell. A phosphoric acid fuel cell (PAFC) is a type of proton exchange fuel cell that utilizes phosphoric acid or a phosphonated ionomer as an electrolyte. The electrolyte can be a highly concentrated or pure liquid phosphoric acid (H₃PO₄) saturated in a silicon carbide (SiC) matrix. PAFC is described as for example in Rak-Hyun Song, S. Dheenadayalan and Dong-Ryul Shin, Effect of silicon carbide particle size in the electrolyte matrix on the performance of a phosphoric acid fuel cell, Journal of Power Sources. Volume 106, Issues 1-2, 167-172 (2002). The phosphoric acid-saturated SiC matrix is in physical contact with the ORR catalyst. Typically, the operating range is about 150° C. to about 210° C. The electrodes are made of carbon paper coated with a finely dispersed platinum catalyst. In a PAFC, hydrogen fuel is oxidized at the anode, releasing electrons that flow through an external circuit, producing electrical power, before reaching the cathode where oxygen is reduced. The phosphoric acid electrolyte facilitates the movement of protons (hydrogen ions) between the anode and cathode, allowing for the conduction of charges and sustaining the electrochemical reactions. The higher operating temperatures of PAFCs (about 150° C. to about 200° C.) compared to other fuel cell types aids in faster reaction kinetics and increases tolerance to impurities in the hydrogen fuel. They are known for their efficiency in converting chemical energy directly into electricity, making them suitable for stationary power generation applications, such as cogeneration systems in industrial settings or utility-scale power plants.

A phosphoric acid fuel cell of the disclosure includes an oxygen reduction reaction (ORR) catalyst comprising: a platinum-palladium alloy catalyst; and, a phosphoric acid or a phosphonated ionomer contacting the platinum-palladium alloy catalyst. ORR catalysts can include nanoparticles of the Pt—Pd alloy catalyst. The Pt—Pd alloy catalyst is contacted by a phosphoric acid-saturated silicon carbide matrix resulting in superior activity and stability. Examples of the phosphoric acid-saturated silicon carbide matrix include polytetrafluoroethylene (PTFE) bonded silicon carbide matrix.

In certain examples discussed herein, the solid solution metal catalyst will include a mixture of platinum-palladium alloy and carbon particles. In some examples, the catalyst composition can also include a phosphoric acid-contained (PA) polymer matrix, such as phosphoric acid doped-pyridine containing aromatic polyether membranes, for example, ammonium-biphosphate ion pair coordinated polyphenylene (QAPOH) contacting the solid solution metal catalyst. In some examples, the catalyst composition can also include a phosphoric acid-contained polymer matrix, such as polybenzimidazole (PBI) contacting the solid solution metal catalyst.

In some examples, catalyst compositions of the present disclosure will have Pd present at a weight ratio relative to the solid solution Pt—Pd alloy catalyst within a range of about 10% to about 90%. In some examples, particles of platinum-palladium alloy catalyst will be fully coated by the phosphoric acid, and in other examples, particles of platinum-palladium alloy catalyst will be partially coated by the phosphoric acid. In some examples, particles of platinum-palladium alloy catalyst will be porous and will be impregnated with the phosphoric acid.

MEAs of the present disclosure include electrodes having composites comprising a platinum-palladium alloy catalyst and a phosphoric acid. The composite of the present disclosure provides enhanced performance of the MEA. More specifically, the composite of the present disclosure comprises a platinum-palladium alloy catalyst; and a phosphoric acid contacting the platinum-palladium alloy catalyst.

In some examples, a phosphonated ionomer is in physical contact with the platinum-palladium alloy catalyst. One example of an ionomer is a phosphonated poly(pentafluostyrene) (PWN) as reported by Kim et al. [Synergistically integrated phosphonated poly(pentafluorostyrene) for fuel cells, Nat Mater. 2021 March; 20 (3): 370-377. doi: 10.1038/s41563-020-00841-z. Epub 2020 Dec. 7.]. Other examples include pSOL® ionomer (poly(tetraflurostyrene phosphonic acid-copentafluorostyrene)) available from Fuel Cell Store.

In some examples, a phosphoric acid-contained polymer matrix is in physical contact with the platinum-palladium alloy catalyst. The presence of a phosphoric acid-contained polymer matrix acts as a protonic bridge between the membrane and catalyst surface as well as a binder for a carbon supported catalyst.

One example of a phosphoric acid-contained polymer matrix that can be employed in examples of the present disclosure is ammonium-biphosphate ion pair coordinated polyphenylene (QAPOH).

A phosphoric acid doping percentage in the phosphoric acid-contained polymer matrix can be about 0 to 50 mg/cm². A molar ratio of phosphoric acid to platinum in the ORR catalyst ranges from about 0 to 100. In some examples, the phosphoric acid can be substituted with a highly conductive phosphonated ionomer.

The present disclosure also includes membrane electrode assemblies (MEAs) for polymer electrolyte membrane fuel cells (PEMFCs). MEAs of the present teachings include electrodes having composites of platinum-palladium alloy catalyst, and, phosphoric acid or a phosphonated ionomer. The disclosed MEAs exhibit notably superior performance at low relative humidity, compared to MEAs lacking phosphoric acid, across a broad range of current densities. The disclosed MEAs also exhibit notably superior performance at high relative humidity, compared to MEAs lacking phosphoric acid or the phosphonated ionomer, at high current densities.

MEAs of the present teachings include a composite cathode having a cathode catalyst mixed with a phosphoric acid or a phosphonated ionomer. The catalyst is a platinum-palladium alloy. The composite cathode improves MEA performance in both low and high humidity.

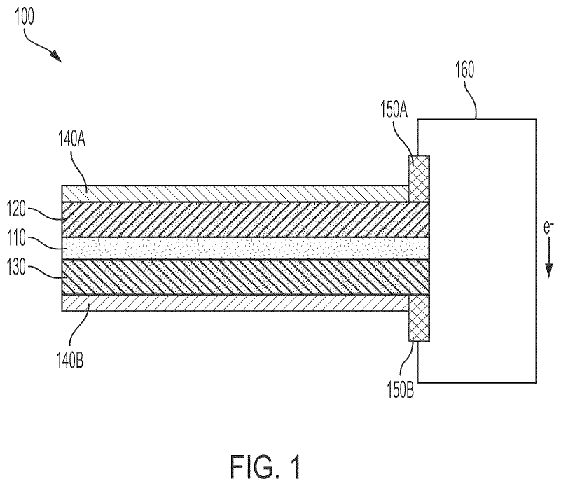

FIG. 1 shows a schematic cross-sectional view of an exemplary, disclosed MEA 100 for a PEMFC. The MEA 100 includes a polymer electrolyte membrane (PEM) 110 configured to support proton transfer (i.e., proton conduction) across the membrane, and to be electrically insulative. The PEM 110 can be a pure polymer membrane or a composite membrane, and can be formed of any suitable material, such as a phosphoric acid containing polymer matrix or a phosphonated polymer or any other suitable material. The MEA 100 further includes an anodic catalyst layer 120, configured to electrolytically catalyze an anodic hydrogen-splitting reaction: H₂→2e⁻+2H⁺.

The anodic catalyst layer can be substantially formed of anodic catalyst particles of platinum, or a platinum alloy supported on carbon, such as carbon black.

The MEA 100 further includes a cathodic catalyst layer 130, configured to catalyze an oxygen reduction reaction: O₂+4e⁻+4H⁺→2H₂O.

The cathodic catalyst layer 130 can include cathodic catalyst particles of platinum-palladium alloy catalyst or a platinum-palladium alloy catalyst supported on carbon, such as carbon black. The cathodic catalyst will typically further include a phosphoric acid or a phosphonated ionomer in admixture with the carbon-supported cathodic catalyst particles.

In some examples, the anodic catalyst layer 120 and/or the cathodic catalyst layer 130 can include a phosphoric acid or phosphonated ionomer. In some examples, the anodic catalyst layer 120 and/or the cathodic catalyst layer 130 can include a solid ionomer, such as a fluorinated polymer, e.g., NAFION®. In some examples, the anodic catalyst layer 120 can include platinum (whether present unalloyed or in an alloy) at a loading density of about 0.05 to about 1.0 mgPt/cm²; and the cathodic catalyst layer 130 can include platinum-palladium alloy at a loading density within a range of from about 0.0.5 to about 1.0 mgPt/cm², inclusive. In some examples, the weight ratio of ionic liquid to carbon-supported cathodic catalyst particles can be about 1:10.

It will be understood that the phosphoric acid-contained polymer matrix places the anodic catalyst layer 120 and the cathodic catalyst layer in protic communication with one another. The MEA 100 can include first and second gas diffusion layers 140A, 140B in contact with the anodic catalyst layer 120 and the cathodic catalyst layer 130, respectively. The first and second gas diffusion layers 140A, 140B are configured to allow hydrogen and oxygen gas to diffuse to the anodic and cathodic catalyst layers, 120, 130, respectively, and to allow water product to diffuse away from the cathodic catalyst layer 130. The MEA 100 can further include anodic and cathodic current collectors 150A, 150B, configured to be in electric communication with the anodic and cathodic catalyst layers 120, 130, respectively, and to connect to be connected to an external circuit 160.

A membrane electrode assembly (MEA) for a polymer electrolyte membrane fuel cell, the MEA comprising: at least one catalyst layer which comprises a phosphoric acid or a phosphonated ionomer.

A membrane electrode assembly (MEA) for a polymer electrolyte membrane fuel cell, the MEA comprising: an anodic catalyst layer; a cathodic catalyst layer comprising carbon supported cathodic catalyst particles of a platinum-palladium alloy, and, a phosphoric acid or a phosphonated ionomer; and a phosphoric acid-contained polymer matrix mediating protic communication between the anodic catalyst layer and the cathodic catalyst layer.

A polymer electrolyte membrane fuel cell (PEMFC) comprising a membrane electrode assembly (MEA), the MEA comprising: an anodic catalyst layer; a cathodic catalyst layer comprising carbon supported cathodic catalyst particles of a platinum-palladium alloy, and, a phosphoric acid or a phosphonated ionomer; and a phosphoric acid-contained polymer matrix mediating protic communication between the anodic catalyst layer and the cathodic catalyst layer.

A high temperature polymer electrolyte membrane fuel cell (HT-PEMFC) comprising a membrane electrode assembly (MEA), the MEA comprising: an anodic catalyst layer; a cathodic catalyst layer comprising carbon supported cathodic catalyst particles of a platinum-palladium alloy, and, a phosphoric acid or a phosphonated polymer; and a phosphoric acid-contained polymer matrix mediating protic communication between the anodic catalyst layer and the cathodic catalyst layer.

In some examples, the ORR catalyst composition can also include a polymeric ionomer, such as NAFION® (DuPont), a perfluorosulfonic acid (PFSA) contacting the platinum-palladium alloy catalyst. Other commercially available examples include FLEMION® (Asahi Glass Company) ACIPLEX® (Asahi Kasei), Aquivion® (Solvay) and FUMION® (FuMA-Tech).

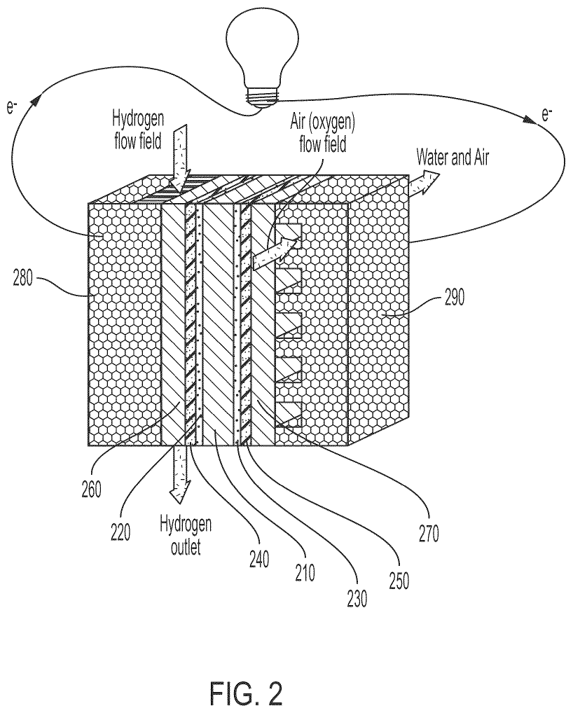

FIG. 2 illustrates an example of a fuel cell 200 having a phosphoric acid-contained polymer matrix 210, an anodic catalytic layer 220 and a cathodic catalytic layer 230. An anode microporous layer 240 contacts the anodic catalytic layer 220. An anode gas diffusion layer 260 contacts the anode microporous layer 240. A cathode microporous layer 250 contacts the cathodic catalytic layer 230. A cathode gas diffusion layer 270 contacts the cathode microporous layer 250. An anode bipolar plate 280 contacts the anode gas diffusion layer 260 and a cathode bipolar plate 290 contacts the cathode gas diffusion layer 270. Hydrogen and air flow within the cell is pictured in FIG. 2. Hydrogen (H₂) is fed to the anode side of the fuel cell and an oxygen source (such as ambient air) is fed to the cathode side of the fuel cell. In FIG. 2, water and excess air are depicted as exiting the cathode side of the fuel cell and unreacted hydrogen is shown as exiting the anode side of the fuel cell.

The anode bipolar plate 280 and the cathode bipolar plate 290 can independently be made from a metal (such as titanium or stainless steel), or a carbon structure (such as graphite). Some metal bipolar plates use a carbon film coating on some or all surfaces of the bipolar plate. U.S. Pat. No. 10,283,785, incorporated herein by reference, teaches use of an amorphous carbon film in bipolar plates. In the fuel cell, the fuel gas and the oxygen gas should be separately supplied to the entire electrode surfaces without being mixed with each other. Therefore, the bipolar plates should be gas tight. Furthermore, the bipolar plates should collect electrons generated by the reaction and have good electric conductivity in order to serve as electric connectors for connecting adjoining single cells when a plurality of single cells are stacked. Moreover, because electrolyte membrane surfaces are strongly acidic, the bipolar plates provide good corrosion resistance. The main purpose of bipolar plate to fulfill in PEMFC stack is to supply fuel (hydrogen) and oxygen to the cell and also to manage heat produced and water flow. It is also used as a backing medium for stacking of individual fuel cells.

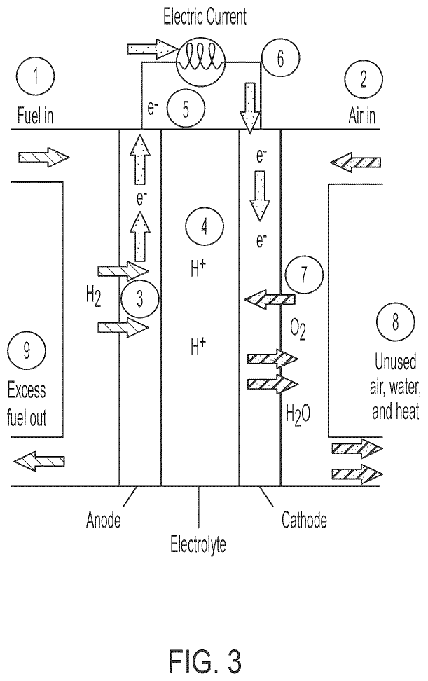

FIG. 3 illustrates how a PEMFC works. At 1, pure hydrogen from the fuel tank or onboard reformer is fueled from the anode side while at 2 oxygen from air is injected from the cathode side with the help of bipolar plates on both sides (not shown). At 3, at the anode, the hydrogen molecule is split into hydrogen ions (protons) and electrons. At 4, the hydrogen ions permeate across the electrolyte to the cathode while at 5 the electrons are forced out of the anode and produce electric current at 6 that flows to the cathode through the external load and produce electric power. At 7, oxygen, usually in the form of air, is supplied to the cathode and combines with the electrons and the hydrogen ions to produce water. Unused air, water, and heat exit on the cathode side at 8 and excess fuel exits out the anode side at 9.

Analysis of nanoparticles of platinum-palladium alloy catalyst by electron microscopic techniques and performance of the membrane assembly electrode of the present disclosure were evaluated as described in the examples. Without our findings, Pt—Pd alloy catalysts would have been treated as inferior catalysts for PAFC and for HT-PEMFCs.

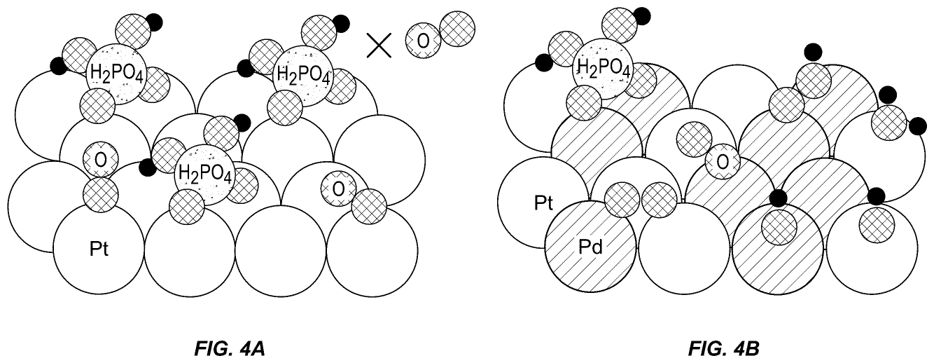

FIGS. 4A and 4B show schematics based on density functional theory calculations of comparison of oxygen (O₂) and phosphate (H₂PO₄⁻) adsorption on pure platinum in contact with phosphoric acid, and on bimetallic platinum-palladium alloy catalyst surface in contact with phosphoric acid. On pure Pt, phosphate adsorption reduces the site number available on pure Pt for oxygen adsorption. On Pt—Pd alloy catalyst, palladium sites can bind phosphate more strongly than platinum sites which could increase availability of sites on platinum for oxygen binding, thereby increasing oxygen concentration on the Pt—Pd catalyst's surface. On Pt—Pd alloy catalyst, Pd also binds phosphate more strongly, which could also free up more sites on Pt sites for binding oxygen, thereby improving the ORR reaction on the Pt—Pd ally catalyst as compared to a pure Pt catalyst.

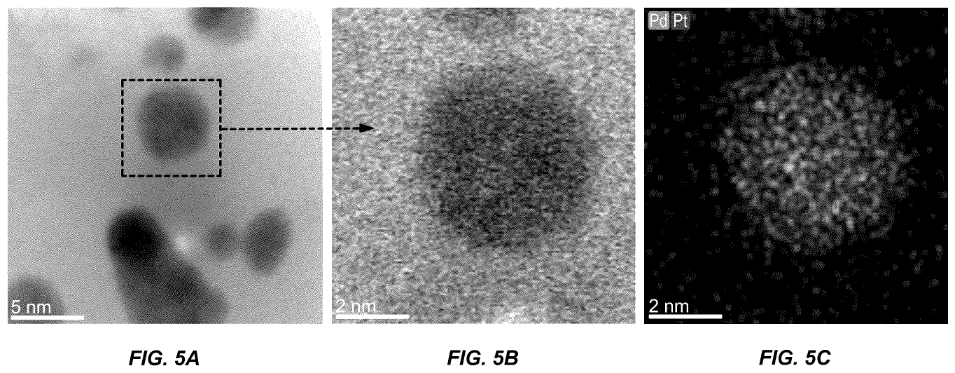

FIGS. 5A, 5B and 5C show TEM image of carbon supported Pt—Pd alloy catalyst (Pt—Pd/C); scanning TEM image of Pt—Pd/C; and corresponding elemental map of a typical Pt—Pd/C nanoparticle. The results show that the Pt—Pd/C alloy catalyst is in the form of a solid solution. FIG. 5C shows that elements Pt and Pd distributed uniformly throughout the nanoparticle, and there was no phase segregation of either element, which suggested the formation of the solid solution structure.

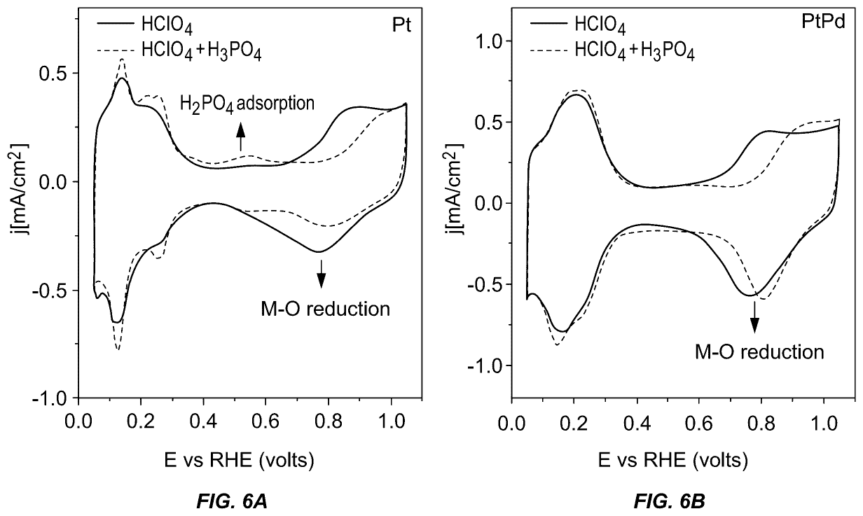

FIGS. 6A and 6B show cyclic voltammetry comparison of carbon supported pure platinum catalyst (Pt/C) and bimetallic carbon supported Pt—Pd alloy catalyst (Pt—Pd/C) in the presence of diluted phosphoric acid (reaction in 0.1 M HClO₄+0.1 M H₃PO₄) or absence of phosphoric acid (reaction in 0.1 M HClO₄) at room temperature (25° C.). Pt/C had a phosphate adsorption peak at about −0.5 V in the anodic scan (shown by arrow in FIG. 6A) which was not seen in Pt—Pd/C. Pt/C showed a smaller decrease in metal-oxidation (M-O) peak area at about-0.8 V in the cathodic scan as compared to the decrease observed in cathodic scan of Pt—Pd/C. This suggests that there was greater oxygen adsorption on Pt—Pd/C as compared to Pt/C. The results also show that oxygen adsorption on Pt—Pd/C was less affected by phosphate adsorption as compared to Pt/C.

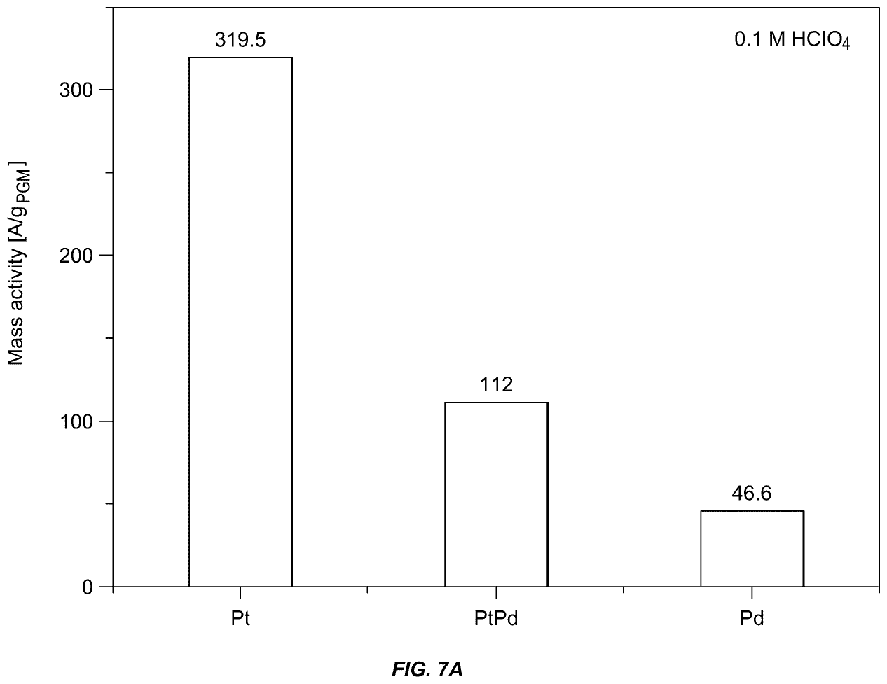

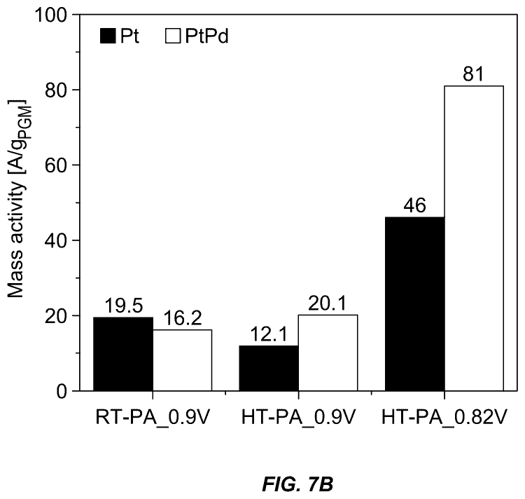

FIG. 7A shows RT-RDE study of comparison of ORR activity of Pt/C, Pt—Pd/C and carbon supported palladium catalyst (Pd/C) in the absence of phosphoric acid (reaction in 0.1 M HClO₄) at room temperature 25° C. The results showed that palladium suppresses ORR activity of pure platinum catalyst. Further, the ORR activity in Pt—Pd/C was also suppressed by platinum but to a lesser extent than by a pure palladium catalyst.

FIG. 7B shows comparison of ORR activity of Pt/C and Pt—Pd/C in presence of phosphoric acid at room temperature from RT-RDE study in 0.1 M HClO₄+0.1 M H₃PO₄ at about 25° C. and at about 0.9 V (RT-PA_0.9V) and presence of concentrated phosphoric acid at higher temperature from HT-RDE study in concentrated H₃PO₄ at about 160° C. and at about 0.9 V (HT-PA_0.9V) and from HT-RDE study at about 160° C. and at about 0.8 V (HT-PA_0.8V). The results showed lesser suppression of ORR activity by Pt—Pd/C at a higher temperature as compared to room temperature. The results showed that Pt—Pd/C was a better catalyst than Pt/C at a higher temperature as compared to room temperature. Higher ORR activity was observed with Pt—Pd/C as compared to Pt/C in the presence of concentrated phosphoric acid at higher temperature (of about 160° C.). The improvement in ORR activity with Pt—Pd/C at higher temperature as compared to Pt/C was more significant at a lower potential (of about 0.82V) as compared to ORR activity at higher temperature and at about 0.9 V. The results show that Pt—Pd/C catalyst in phosphoric acid unexpectedly acts as a better catalyst at high temperature and lower potential than Pt/C catalyst when compared to the catalytic activity of Pt—Pd/C at room temperature.

Our results show that platinum-palladium alloy catalyst in the presence of phosphoric acid or phosphonated ionomer can significantly improve performance of an MEA, and performance of a fuel cell.

### EXAMPLES

Various aspects of the present disclosure are further illustrated with respect to the following examples. It is to be understood that these examples are provided to illustrate specific examples of the present disclosure and should not be construed as limiting the scope of the present disclosure in or to any particular aspect.

### Example 1. Density Functional Analysis of Platinum-Palladium Nanoparticles in Phosphoric Acid

Density functional theory (DFT) calculations were performed on Pt/C in phosphoric acid and Pt—Pd/C in phosphoric acid as described in Lin et al. (Honghong Lin, Zhendong Hu, Katie H. Lim, Siwen Wang, Li Qin Zhou, Liang Wang, Gaohua Zhu, Keiichi Okubo, Chen Ling, Yu Seung Kim, and Hongfei Jia, High-Temperature Rotating Disk Electrode Study of Platinum Bimetallic Catalysts in Phosphoric Acid, ACS Catal. 2023, 13, 5635-5642), incorporated herein by reference. Schematic is provided in FIGS. 4A and 4B.

### Example 2. Room Temperature Rotating Disk Electrode (RT-RDE) Experiment

Three-electrode cell components and conditioning protocols were prepared as described in Nagai, T., Jahn, C., and Jia, H. (2019). Improved Accelerated Stress Tests for ORR Catalysts Using a Rotating Disk Electrode. J. Electrochem. Soc. 166, F3111-F3115. 10.1149/2.0161907jes. In brief, the catalyst ink was prepared by mixing the catalyst with 25 vol % 2-propanol aqueous solution and 5 wt % NAFION® solution. The mixture was sonicated in an ice bath for 60 min to get uniform dispersion. 10 μL of the catalyst ink was pipetted on a clean glassy carbon disk electrode (GC, 5 mm in diameter) and dried in air at room temperature by using an inverted rotator at 200 rpm. The NAFION® to carbon ratio was 0.5. The catalyst loading on the electrode was 15 μgPt/cm².

Cyclic voltammetry (CV) in 0.1 M HClO₄ or in 0.1 M HClO₄+0.1 M H₃PO₄ was conducted between 0.05-1.05 V at 100 mV/s as described in Lin et al. (Honghong Lin, Zhendong Hu, Katie H. Lim, Siwen Wang, Li Qin Zhou, Liang Wang, Gaohua Zhu, Keiichi Okubo, Chen Ling, Yu Seung Kim, and Hongfei Jia, High-Temperature Rotating Disk Electrode Study of Platinum Bimetallic Catalysts in Phosphoric Acid, ACS Catal. 2023, 13, 5635-5642), incorporated herein by reference.

### Example 3. High Temperature Rotating Disk Electrode (HT-RDE) Experiment

The cell component was the same as the RT-RDE setup in Example 2. Besides, an oil bath was used to heat the cell, and a thermometer isolated in a glass tube was used to monitor the temperature. 10 μL of the catalyst ink was pipetted on a clean glassy carbon disk electrode (GC, 5 mm in diameter) and dried in air at room temperature by using an inverted rotator at 200 rpm. The NAFION® to carbon ratio was 0.9. The catalyst loading on the electrode was 60 μgPt/cm².

The present disclosure can be applicable to various other aspects, such as a vehicle driven by utilizing electric power of the fuel cell, a power generation system that supplies electric power of the fuel cell, and other articles comprising the fuel cells. In some examples, the vehicle can be a passenger car or truck. In some examples the power generation system can be stationary. The present disclosure is not limited to the above aspects or examples but can be implemented by any of various other aspects or examples within the scope of the disclosure.

Further, the disclosure comprises additional notes and examples as detailed below.

Clause 1. An oxygen reduction reaction (ORR) catalyst comprising: a platinum-palladium alloy catalyst; and, a phosphoric acid or a phosphonated ionomer contacting the platinum-palladium alloy catalyst.

Clause 2. The ORR catalyst of clause 1, wherein the platinum-palladium alloy catalyst is a solid solution metal catalyst.

Clause 3. The ORR catalyst of any one of clauses 1 to 2, wherein the platinum-palladium alloy catalyst comprises nanoparticles of a platinum-palladium alloy.

Clause 4. The ORR catalyst of any of clauses 1 to 3, wherein the platinum-palladium alloy catalyst is at a cathode.

Clause 5. The ORR catalyst of clause 1, wherein an ORR is performed at a temperature ranging from about 80° C. to about 230° C.

Clause 6. The ORR catalyst of claim 1, wherein an ORR is performed at a voltage ranging from about 0 to about 1.23 volts.

Clause 7. A phosphoric acid fuel cell (PAFC) comprising the ORR catalyst according to any of clauses 1-6.

Clause 8. The PAFC of clause 7, further comprising a phosphoric acid-saturated polytetrafluoroethylene (PTFE) bonded silicon carbide matrix in physical contact with the ORR catalyst.

Clause 9. The ORR catalyst according to any of clauses 1 to 6, wherein the phosphonated ionomer is poly(2,3,5,6-tetrafluorostyrene-4-phosphonic acid) (PWN) or poly(tetraflurostyrene phosphonic acid-copentafluorostyrene) (pSOL®).

Clause 10. The ORR catalyst according to any of clauses 1 to 6 and 9 further comprising a secondary ionomer.

Clause 11. The ORR catalyst according to any of clauses 1 to 6 and 9 to 10, wherein the secondary ionomer is NAFION®.

Clause 12. The ORR catalyst according to any of clauses 1 to 6 and 9 to 11, further comprising a phosphoric acid-contained polymer matrix in physical contact with the platinum-palladium alloy catalyst.

Clause 13. The ORR catalyst according to any of clauses 1 to 6 and 9, wherein the phosphoric acid-contained polymer matrix is a phosphoric acid doped-pyridine containing aromatic polyether membrane, a phosphoric acid-doped polybenzimidazole (PA-PBI), or a phosphoric acid-doped ammonium-biphosphate ion pair coordinated polyphenylene (PA-QAPOH).

Clause 14: The ORR catalyst of clause 12, wherein a phosphoric acid doping percentage in the phosphoric acid-contained polymer matrix is about 0 to about 50 mg/cm².

Clause 15: The ORR catalyst according to any of clauses 1 to 14 clause 9, wherein a molar ratio of phosphoric acid to platinum in the ORR catalyst ranges from about 0 to 100.

Clause 16. A polymer electrolyte membrane fuel cell (PEMFC) comprising the ORR catalyst according to any one of clauses 1 to 6 and 9 to 15.

Clause 17. A membrane electrode assembly (MEA), the MEA comprising: at least one catalyst layer which comprises a platinum-palladium alloy catalyst; and, a phosphoric acid or a phosphonated ionomer.

Clause 18. The MEA of clause 17, wherein the platinum-palladium alloy catalyst comprises nanoparticles of the platinum-palladium alloy catalyst.

Clause 19. The MEA according to any of clauses 17 to 18, wherein the platinum-palladium alloy catalyst is a solid solution metal catalyst.

Clause 20. The MEA according to any of clauses 17 to 19, wherein the platinum-palladium alloy catalyst is at a cathode.

Clause 21. The MEA according to any of clauses 17 to 20, further comprising a phosphoric acid-contained polymer matrix in physical contact with the platinum-palladium alloy catalyst.

Clause 22. The MEA according to any of clauses 17 to 21, wherein the phosphoric acid-d polymer is a phosphoric acid doped-pyridine containing aromatic polyether membrane, a phosphoric acid-doped polybenzimidazole (PA-PBI), or a phosphoric acid-doped ammonium-biphosphate ion pair coordinated polyphenylene (PA-QAPOH).

Clause 23. The MEA according to any of clauses 17 to 22, wherein the phosphonated ionomer is poly(2,3,5,6-tetrafluorostyrene-4-phosphonic acid) (PWN) or poly(tetraflurostyrene phosphonic acid-copentafluorostyrene) (pSOL®).

Clause 24. A high temperature polymer electrolyte membrane fuel cell (HT-PEMFC) comprising the MEA according to any of clauses 17 to 23, wherein an ORR is performed at a temperature ranging from about 80° C. to about 230° C.

Clause 25. A membrane electrode assembly (MEA), the MEA comprising:
an anodic catalyst layer;
a cathodic catalyst layer comprising carbon supported cathodic catalyst particles of a platinum-palladium alloy, and, a phosphoric acid or a phosphonated ionomer; and,
a phosphoric acid-contained polymer matrix mediating protic communication between the anodic catalyst layer and the cathodic catalyst layer.

Clause 26. The MEA of clause 25, wherein the cathodic catalyst particles are nanoparticles of the platinum-palladium alloy.

Clause 27. The MEA according to any of clauses 25 to 26, wherein the phosphoric acid-contained polymer matrix is a phosphoric acid doped-pyridine containing aromatic polyether membrane, a phosphoric acid-doped polybenzimidazole (PA-PBI), or a phosphoric acid-doped ammonium-biphosphate ion pair coordinated polyphenylene (PA-QAPOH).

Clause 28. The MEA according to any of clauses 25 to 27, wherein the phosphonated ionomer is poly(2,3,5,6-tetrafluorostyrene-4-phosphonic acid) (PWN) or poly(tetraflurostyrene phosphonic acid-copentafluorostyrene) (pSOL®).

Clause 29. A polymer electrolyte membrane fuel cell (PEMFC) comprising a MEA according to any of clauses 25 to 28.

Clause 30. A polymer electrolyte membrane fuel cell (PEMFC) comprising a membrane electrode assembly (MEA), the MEA comprising:
an anodic catalyst layer;
a cathodic catalyst layer comprising carbon supported cathodic catalyst particles of a platinum-palladium alloy, and, a phosphoric acid or a phosphonated ionomer; and,
a phosphoric acid-contained polymer matrix mediating protic communication between the anodic catalyst layer and the cathodic catalyst layer.

Clause 31. The PEMFC of clause 30, wherein the cathodic catalyst particles comprises nanoparticles of the platinum-palladium alloy.

Clause 32. A composite cathode having a cathode catalyst mixed with phosphoric acid.

Clause 33. The composite cathode catalyst of clause 32, comprising a platinum-palladium alloy.

Clause 34. A composite cathode having a cathode catalyst mixed with a phosphonated ionomer.

Clause 35. The composite cathode catalyst of clause 34, comprising a platinum-palladium alloy.

Clause 36. A fuel cell comprising an oxygen reduction reaction (ORR) catalyst, wherein the ORR catalyst comprises: a platinum-palladium alloy; and, a phosphoric acid or a phosphonated ionomer contacting the platinum palladium alloy catalyst.

Clause 37. The fuel cell of clause 36, wherein the fuel cell is a phosphoric acid fuel cell (PFAC).

Clause 38. The fuel cell of clause 37, wherein the fuel cell is a HT-PEMFC.

Clause 39. A phosphoric acid fuel cell comprising an anodic catalyst layer, a cathodic catalyst layer, and a phosphoric acid-saturated silicon carbide matrix, wherein the cathode catalyst layer comprises a carbon-supported platinum-palladium alloy catalyst, and, a phosphoric acid or a phosphonated ionomer.

Clause 40. A high temperature polymer exchange membrane fuel cell (HT-PEMFC) comprising an anodic catalyst layer, a cathodic catalyst layer and a phosphoric acid-contained polymer matrix, wherein the cathode catalyst layer comprises a carbon-supported platinum-palladium alloy catalyst and a phosphoric acid.

Clause 41. The HT-PEMFC of clause 40, wherein the phosphoric acid-contained polymer matrix is a phosphoric acid doped-pyridine containing aromatic polyether membrane, a phosphoric acid-doped polybenzimidazole (PA-PBI), or a phosphoric acid-doped ammonium-biphosphate ion pair coordinated polyphenylene (PA-QAPOH).

Clause 42. A high temperature polymer exchange membrane fuel cell (HT-PEMFC) comprising an anodic catalyst layer, a cathodic catalyst layer and a phosphoric acid-contained polymer matrix, wherein the cathode catalyst layer comprises a carbon-supported platinum-palladium alloy catalyst and a phosphonated ionomer.

Clause 43. The HT_PEMFC of clause 42, wherein the phosphoric acid-contained polymer matrix is a phosphoric acid doped-pyridine containing aromatic polyether membrane, a phosphoric acid-doped polybenzimidazole (PA-PBI), or a phosphoric acid-doped ammonium-biphosphate ion pair coordinated polyphenylene (PA-QAPOH).

Clause 44. A HT-RDE comprising the ORR catalyst of clause 1.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple examples having stated features is not intended to exclude other embodiments having additional features, or other examples incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an example can or may comprise certain elements or features does not exclude other examples of the present technology that do not contain those elements or features.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. An oxygen reduction reaction (ORR) catalyst comprising:
a platinum-palladium alloy catalyst; and
a phosphoric acid or a phosphonated ionomer contacting the platinum-palladium alloy catalyst.

2. The ORR catalyst of claim 1, wherein the platinum-palladium alloy catalyst is a solid solution metal catalyst.

3. The ORR catalyst of claim 1, wherein the platinum-palladium alloy catalyst comprises nanoparticles of a platinum-palladium alloy.

4. The ORR catalyst of claim 1, wherein the platinum-palladium alloy catalyst is at a cathode.

5. The ORR catalyst of claim 1, wherein an ORR is performed at a temperature ranging from about 80° C. to about 230° C.

6. A phosphoric acid fuel cell (PAFC) comprising the ORR catalyst of claim 1 and a phosphoric acid-saturated silicon carbide matrix in physical contact with the ORR catalyst.

7. A high-temperature polymer electrolyte membrane fuel cell (HT-PEMFC) comprising the ORR catalyst of claim 1 and a phosphoric acid-contained polymer matrix, wherein the phosphoric acid-contained polymer matrix is in physical contact with the ORR catalyst.

8. The HT-PEMFC of claim 7, wherein the phosphoric acid-contained polymer matrix is a phosphoric acid-polybenzimidazole (PA-PBI) or a phosphoric acid-doped ammonium-biphosphate ion pair coordinated polyphenylene (PA-QAPOH).

9. The ORR catalyst of claim 1, wherein the phosphonated ionomer is poly (2,3,5,6-tetrafluorostyrene-4-phosphonic acid) (PWN) or poly(tetraflurostyrene phosphonic acid-copentafluorostyrene).

10. A membrane electrode assembly (MEA), the MEA comprising:
at least one catalyst layer which comprises a platinum-palladium alloy catalyst; and
a phosphoric acid or a phosphonated ionomer.

11. The MEA of claim 10, wherein platinum-palladium alloy catalyst comprises nanoparticles of the platinum-palladium alloy catalyst.

12. The MEA of claim 10, wherein the platinum-palladium alloy catalyst is at a cathode.

13. The MEA of claim 10, further comprising a phosphoric acid-contained polymer matrix in physical contact with the platinum-palladium alloy catalyst.

14. The MEA of claim 13, wherein the phosphoric acid-contained polymer matrix is a phosphoric acid-doped polybenzimidazole (PA-PBI) or a phosphoric acid-doped ammonium-biphosphate ion pair coordinated polyphenylene (PA-QAPOH).

15. The MEA of claim 10, wherein the phosphonated ionomer is poly (2,3,5,6-tetrafluorostyrene-4-phosphonic acid) (PWN) or poly(tetraflurostyrene phosphonic acid-copentafluorostyrene).

16. A membrane electrode assembly (MEA), the MEA comprising:
an anodic catalyst layer;
a cathodic catalyst layer comprising carbon supported cathodic catalyst particles of a platinum-palladium alloy, and, a phosphoric acid or a phosphonated ionomer; and
a phosphoric acid-contained polymer matrix mediating protic communication between the anodic catalyst layer and the cathodic catalyst layer.

17. The MEA of claim 16, wherein the cathodic catalyst particles are nanoparticles of the platinum-palladium alloy.

18. The MEA of claim 16, wherein the phosphoric acid-contained polymer matrix is a phosphoric acid-doped polybenzimidazole (PA-PBI) or a phosphoric acid-doped ammonium-biphosphate ion pair coordinated polyphenylene (PA-QAPOH).

19. The MEA of claim 16, wherein the phosphonated ionomer is poly (2,3,5,6-tetrafluorostyrene-4-phosphonic acid) (PWN) or poly(tetraflurostyrene phosphonic acid-copentafluorostyrene).

20. A polymer electrolyte membrane fuel cell (PEMFC) comprising the MEA according to claim 16.
